(19) United States
(12) Patent Application Publication
(10) Pub. No.: US 2021/0364852 A1
(43) Pub. Date: Nov. 25, 2021

(54) DISPLAY PANEL, DISPLAY DEVICE AND METHOD FOR MANUFACTURING DISPLAY PANEL

(71) Applicant: BOE TECHNOLOGY GROUP CO., LTD., Beijing (CN)

(72) Inventors: Hongrun WANG, Beijing (CN); Ge SHI, Beijing (CN)

(73) Assignee: BOE TECHNOLOGY GROUP CO., LTD., Beijing (CN)

(21) Appl. No.: 16/604,370

(22) PCT Filed: Apr. 23, 2019
(86) PCT No.: PCT/CN2019/083917

§ 371 Date: Oct. 10, 2019

(30) Foreign Application Priority Data
May 10, 2018 (CN) 201810445045.8

(51) Int. Cl. G02F 1/1335; G02F 1/1341

(52) U.S. Cl. CPC G02F 1/133531; G02F 2201/56; G02F 1/1341; G02F 1/133548

(57) ABSTRACT

A display panel, a display device, and a method for manufacturing a display panel are disclosed. The display panel includes: a liquid crystal layer, a first polarizer and a second polarizer. The first polarizer and the second polarizer are respectively on both sides of the liquid crystal layer, the first polarizer includes a plurality of first polarizing structures, and a polarization direction of at least one of the first polarizing structures is not perpendicular to a polarization direction of the second polarizer.

The application claims priority to Chinese patent application No. 201810445045.8, filed on May 10, 2018, the entire disclosure of which is incorporated herein by reference as part of the present application.

### TECHNICAL FIELD

Embodiments of the present disclosure relate to a display panel, a display device, and a method for manufacturing a display panel.

### BACKGROUND

Currently, liquid crystal display (LCD) devices are more and more widely used because of advantages such as low power consumption, miniaturization, thinness, light weight, etc. A liquid crystal display panel includes a liquid crystal layer, an upper polarizer and a lower polarizer, and the upper polarizer and the lower polarizer are respectively disposed on both sides of the liquid crystal layer. Each of the polarizers of the traditional liquid crystal display panel has only one polarization direction, and the polarization direction of the upper polarizer and the polarization direction of the lower polarizer are perpendicular to each other. The retardation of light can be influenced by applying a voltage to the liquid crystal, thereby achieving the control of the brightness of the light.

### SUMMARY

At least an embodiment of the present disclosure provides a display panel, and the display panel includes: a liquid crystal layer, a first polarizer and a second polarizer, the first polarizer and the second polarizer are respectively on both sides of the liquid crystal layer; and the first polarizer includes a plurality of first polarizing structures, and a polarization direction of at least one of the first polarizing structures is not perpendicular to a polarization direction of the second polarizer.

For example, in the display panel provided by an embodiment of the present disclosure, the plurality of first polarizing structures are disposed along a first direction; the display panel includes a first side and a second side, and the first side is longer than the second side; and the first direction is parallel to a direction of the first side of the display panel.

For example, in the display panel provided by an embodiment of the present disclosure, the first polarizer includes a wire grid polarizer, and at least one of the first polarizing structures includes a plurality of wire grids in a parallel arrangement.

For example, in the display panel provided by an embodiment of the present disclosure, the wire grid polarizer is a metal wire grid polarizer, and each of the first polarizing structures includes a plurality of metal wire grids in a parallel arrangement.

For example, in the display panel provided by an embodiment of the present disclosure, polarization directions of the plurality of first polarizing structures of the first polarizer are not all identical, and the polarization direction of the second polarizer is identical at each position of the second polarizer.

For example, in the display panel provided by an embodiment of the present disclosure, in the first direction, the first polarizer includes an intermediate region, and a first edge region and a second edge region respectively on both sides of the intermediate region; along a direction from the intermediate region to the first edge region, an angle between a polarization direction of each of the first polarizing structures and the polarization direction of the second polarizer gradually decreases; and along a direction from the intermediate region to the second edge region, an angle between a polarization direction of each of the first polarizing structures and the polarization direction of the second polarizer gradually decreases.

For example, in the display panel provided by an embodiment of the present disclosure, in the first direction, the first polarizer includes an intermediate region, and a first edge region and a second edge region respectively on both sides of the intermediate region; each of the first edge region and the second edge region includes at least one sub-edge region, and sub-edge regions on both sides of the intermediate region are symmetrical with respect to a centerline of the display panel along the first direction; and each of the sub-edge regions includes one of the first polarizing structures, and polarization directions of first polarizing structures of symmetrical sub-edge regions have an identical angle with the polarization direction of the second polarizer.

For example, in the display panel provided by an embodiment of the present disclosure, each of the first edge region and the second edge region includes 2 to 100 sub-edge regions.

For example, in the display panel provided by an embodiment of the present disclosure, each of the sub-edge regions has an identical width in the first direction.

For example, in the display panel provided by an embodiment of the present disclosure, along the direction from the intermediate region to the first edge region, widths of the plurality of sub-edge regions gradually decrease; and along the direction from the intermediate region to the second edge region, widths of the plurality of sub-edge regions gradually decrease.

For example, in the display panel provided by an embodiment of the present disclosure, the second polarizer is a metal wire grid polarizer.

For example, in the display panel provided by an embodiment of the present disclosure, the display panel is a curved display panel.

For example, in the display panel provided by an embodiment of the present disclosure, the display panel is an advanced super dimension switch display panel.

For example, in the display panel provided by an embodiment of the present disclosure, the second polarizer includes a plurality of second polarizing structures, and polarization directions of at least two of the second polarizing structures are different from each other.

For example, in the display panel provided by an embodiment of the present disclosure, the plurality of first polarizing structures are disposed along a second direction; the display panel includes a first side and a second side, and the first side is longer than the second side; and the second direction is parallel to a direction of the second side of the display panel.

At least an embodiment of the present disclosure further provides a display device, including the display panel provided by any one of the embodiments of the present disclosure.

At least an embodiment of the present disclosure further provides a method for manufacturing a display panel, and the method includes: forming a liquid crystal layer, and disposing a first polarizer and a second polarizer respectively on both sides of the liquid crystal layer; and the first polarizer includes a plurality of first polarizing structures, and a polarization direction of at least one of the first polarizing structures is not perpendicular to a polarization direction of the second polarizer.

### BRIEF DESCRIPTION OF THE DRAWINGS

In order to clearly illustrate the technical solution of the embodiments of the present disclosure, the drawings of the embodiments will be briefly described in the following. It is obvious that the described drawings in the following are only related to some embodiments of the present disclosure and thus are not limitative of the present disclosure.

FIG. 1 is a structural schematic diagram of a display panel provided by at least an embodiment of the present disclosure;

FIG. 2 is a structural schematic diagram of a first polarizer comprising a plurality of first polarizing structures provided by at least an embodiment of the present disclosure;

FIG. 3 is a structural schematic diagram of a first polarizer comprising three first polarizing structures provided by at least an embodiment of the present disclosure:

FIG. 4A is a schematic diagram of a contrast simulation result in a case where a polarization direction of a first polarizer and a polarization direction of a second polarizer are perpendicular to each other provided by at least an embodiment of the present disclosure;

FIG. 4B is a schematic diagram of a contrast simulation result in a case where polarization directions of first polarizing structures of a first polarizer are not all perpendicular to a polarization direction of the second polarizer provided by at least an embodiment of the present disclosure;

FIG. 5 is a structural schematic diagram of a display panel being divided into seven regions along a direction of a long side of the display panel provided by at least an embodiment of the present disclosure; and

FIG. 6 is a structural schematic diagram of angles between a polarization direction of a first polarizing structure and a polarization direction of a second polarizer in partial regions of the display panel in FIG. 5.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, “coupled”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

For a curved display panel, in a case where the curved display panel is bent, the deformation stress of the glass generates an extra optical retardation (i.e., a redundant optical retardation, where the extra optical retardation refers to optical retardation generated in a bended display panel with respect to the display panel without being bent), and the extra optical retardation may affect the polarization direction of the light, thereby resulting in a light leakage problem of the curved display panel in a dark state.

For example, by taking the liquid crystal display panel as an example, the first polarizer and the second polarizer disposed on both sides of the liquid crystal layer of the traditional liquid crystal display panel generally have only one polarization direction. Because in an ideal case (i.e., in a case without light leakage), the extra optical retardation Δnd′ generated when the liquid crystal display panel is in the dark state is 0, that is. Δnd′=0, and the polarization direction of the first polarizer and the polarization direction of the second polarizer are perpendicular to each other, so that in this case, the light transmittance T of the liquid crystal display panel is 0, that is, light cannot pass, thereby achieving a dark state display.

In a case where the liquid crystal display panel is in a bright state, the light transmittance T satisfies:

$$T = {sin}^{2} ( 2 θ ) {sin}^{2} ( \frac{Δ n * d * π}{λ} ) / 2.$$

in which θ is an azimuth angle of a liquid crystal, Δn is a refractive index of a liquid crystal, d is a thickness of the liquid crystal layer, and λ is a wavelength of incident light.

However, in a case where the liquid crystal display panel is bent (i.e., the liquid crystal display panel is a curved liquid crystal display panel), because the deformation stress of the glass may generate an extra optical retardation, that is, Δnd′≠0, and the extra optical retardation may affect the polarization direction of the light, the light transmittance T of the liquid crystal display panel in the dark state is not 0, thereby resulting in the light leakage phenomenon in a case where the liquid crystal display panel is in the dark state.

For the problem of light leakage in the dark state, the influence of the deformation stress of the glass is usually reduced by reducing the thickness of the glass, but for a large-sized curved display panel, the reduction in the thickness of the glass may reduce the production efficiency and increase the production cost, and the strength of the glass of a reduced thickness is greatly reduced, thereby causing the glass to be easily broken.

At least an embodiment of the present disclosure provides a display panel, a display device, and a method for manufacturing a display panel. The display panel can compensate for the influence of the extra optical retardation, which is generated in a case where the display panel is bent, on the polarization direction of light, thereby alleviating the light leakage phenomenon of the display panel in the dark state and allowing the display panel to achieve a better image display effect. Moreover, the thickness of the glass of the display panel does not need to be reduced, so that the production efficiency of the display panel is not affected and the quality of the display panel is not reduced.

In the following, the embodiments of the present disclosure will be described in detail with reference to the accompanying drawings. It should be noted that the same reference numerals used in different drawings refer to the same described components.

At least an embodiment of the present disclosure provides a display panel, and the display panel includes: a liquid crystal layer, a first polarizer and a second polarizer. The first polarizer and the second polarizer are respectively disposed on both sides of the liquid crystal layer. The first polarizer includes a plurality of first polarizing structures, and a polarization direction of at least one of the first polarizing structures is not perpendicular to a polarization direction of the second polarizer.

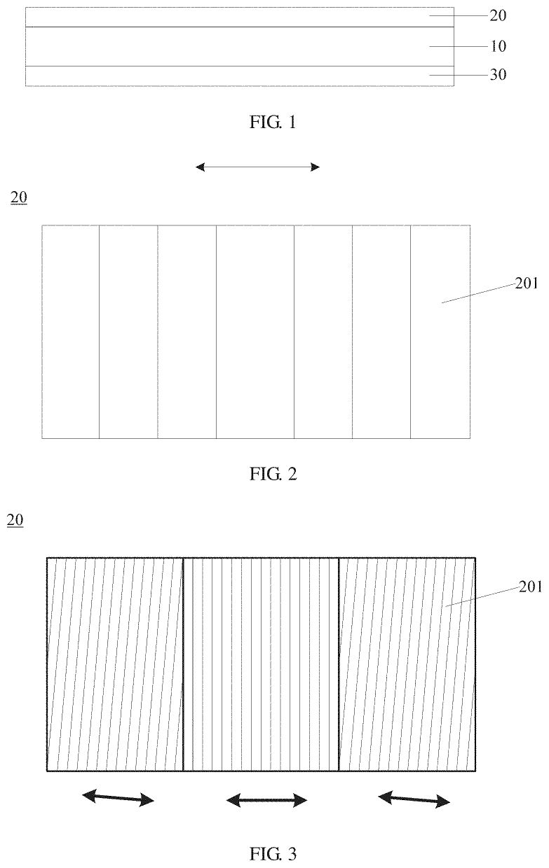

FIG. 1 is a structural schematic diagram of a display panel provided by at least an embodiment of the present disclosure. As illustrated in FIG. 1, the display panel includes a liquid crystal layer 10, a first polarizer 20 and a second polarizer 30, and the first polarizer 20 and the second polarizer 30 are respectively disposed on both sides of the liquid crystal layer 10.

For example, the display panel may be a curved display panel, such as a curved liquid crystal display panel. The embodiments of the present disclosure do not limit the type of the curved liquid crystal display panel. For example, the display panel may be an advanced super dimension switch (ADS) type curved display panel, may be an in-plane switching (IPS) type curved display panel, and may be a twisted nematic (TN) type curved display panel or a vertical alignment (VA) type curved display panel, etc.

Because the light leakage phenomenon of the ADS type curved display panel in the dark state is relatively serious in a case where the ADS type curved display panel is bent, the embodiments of the present disclosure will be described below by taking the ADS type curved display panel as an example, but the embodiments of the present disclosure are not limited thereto.

FIG. 2 is a structural schematic diagram of a first polarizer comprising a plurality of first polarizing structures provided by at least an embodiment of the present disclosure. As illustrated in FIG. 2, along a first direction (as indicated by the double arrow in FIG. 2) of the curved display panel, the first polarizer 20 is divided into a plurality of first polarizing structures 201, and a polarization direction of at least one of the first polarizing structures 201 is not perpendicular to a polarization direction of the second polarizer 30. For example, polarization directions (i.e., optical axis directions of the first polarizing structures 201) of the plurality of first polarizing structures 201 are not all identical, and the polarization directions of the first polarizing structures 201 are not all perpendicular to the polarization direction of the second polarizer 30.

For example, the curved display panel includes a first side and a second side, and the first side is longer than the second side. The first direction is parallel to a direction of the first side of the curved display panel, and for example, the first direction may be a horizontal viewing direction of the curved display panel.

It should be noted that the horizontal viewing direction of the curved display panel refers to a horizontal direction where a person views the display image of the display panel. The horizontal viewing direction of the curved display panel is only related to the placement position of the display panel, and is not related to the viewing angle of the person.

For example, the curved display panel is generally bent along the direction (for example, the horizontal viewing direction) of the long side (i.e., the first side) of the curved display panel. In some other embodiments of the present disclosure, according to practical application requirements, the curved display panel may also be bent along other directions, and for example, may be bent along a direction (i.e., the second direction) parallel to the short side (i.e., the second side) of the curved display panel. The embodiments of the present disclosure are not limited in this aspect. For example, in a case where the curved display panel is bent along the second direction, the plurality of first polarizing structures 201 may be disposed, for example, in the direction parallel to the short side of the curved display panel.

It should be noted that the embodiments of the present disclosure do not limit the upper-lower position relationship of the first polarizer 20 and the second polarizer 30 respectively disposed on both sides of the liquid crystal layer 10. For example, the first polarizer 20 may be the upper polarizer, and the second polarizer 30 may be the lower polarizer, or the first polarizer 20 may be the lower polarizer, and the second polarizer 30 may be the upper polarizer.

For example, a case where the polarization directions of the plurality of first polarizing structures 201 are not all identical may be a case where the polarization direction of each of the plurality of first polarizing structures 201 is different from each other, or may be a case where polarization directions of some of the plurality of first polarizing structures 201 are identical, and polarization directions of some of the plurality of first polarizing structures 201 are different from each other. Moreover, those skilled in the art should understand that one first polarizing structure 201 has only one polarization direction.

For example, based on the above description, the number of the first polarizing structures 201 included in the first polarizer 20 is not limited, and may be, for example, 3, 5, 7, 101, 201, etc. The number of the first polarizing structures 201 may be appropriately determined according to the size of the curved display panel, the bending degree of the curved display panel, and so on. The embodiments of the present disclosure are not limited in this aspect.

For example, in the embodiments of the present disclosure as illustrated in FIG. 2, the first polarizing structure 201 is in a shape of a rectangle, and in other embodiments of the present disclosure, the first polarizing structure 201 may also be in other shapes according to practical requirements (e.g., the outline of the curved display panel). The embodiments of the present disclosure are not limited in this aspect.

For example, a case where the polarization directions of the first polarizing structures 201 are not all perpendicular to the polarization direction of the second polarizer 30 may be a case where the polarization direction of each of the first polarizing structures 201 is not perpendicular to the polarization direction of the second polarizer 30, or may be a case where polarization directions of some of the first polarizing structures 201 are perpendicular to the polarization direction of the second polarizer 30, and polarization directions of some of the first polarizing structures 201 are not perpendicular to the polarization direction of the second polarizer 30. The embodiments of the present disclosure are not limited in this aspect.

For example, regarding the polarization direction of the second polarizer 30, the polarization direction of the second polarizer 30 may be identical at each position of the second polarizer 30, and the polarization directions of the plurality of first polarizing structures 201 of the first polarizer 20 are disposed to allow the polarization directions of the plurality of first polarizing structures 201 of the first polarizer 20 to be not all perpendicular to the polarization direction of the second polarizer 30. Alternatively, the second polarizer 30 may be further divided into a plurality of second polarizing structures which are in one-to-one correspondence with the plurality of first polarizing structures 201 of the first polarizer 20, and polarization directions of the plurality of second polarizing structures of the second polarizer 30 are not all identical. The polarization directions of the plurality of first polarizing structures 201 of the first polarizer 20 and the polarization directions of the plurality of second polarizing structures of the second polarizer 30 are disposed to allow the polarization directions of the plurality of first polarizing structures 201 of the first polarizer 20 to be not all perpendicular to the polarization direction of the second polarizer 30.

In order to simplify the manufacturing process of the curved display panel, in the embodiments of the present disclosure, the case where the polarization direction of the second polarizer 30 is identical at each position of the second polarizer 30, that is, the second polarizer 30 has only one polarization direction, is taken as an example to illustrate, but the embodiments of the present disclosure are not limited in this aspect.

For example, in the embodiments of the present disclosure, the first polarizer 20 may be a wire grid polarizer, and at least one of the first polarizing structures 201 includes a plurality of wire grids in a parallel arrangement. For example, the plurality of wire grids in the parallel arrangement may be arranged along the direction of the long side of the curved display panel, or may be arranged along the direction of the short side of the curved display panel. The embodiments of the present disclosure are not limited in this aspect.

For example, the embodiments of the present disclosure do not limit the types of the first polarizer 20 and the second polarizer 30, and the first polarizer 20 and the second polarizer 30 may be any type of polarizer. For example, each of the first polarizer 20 and the second polarizer 30 may be a metal wire grid polarizer (WGP), an iodine-based polarizer, a dye-based polarizer, etc.

The principle that the metal wire grid polarizer can obtain linear polarized light is described as follows. Because the metal wire grid polarizer is composed of metal wire grids in a parallel arrangement, the electrons in the metal wire grids can only move along the metal wire grids. In a case where light is irradiated on the metal wire grids, the vibration of the light wave electric vector in the direction of the metal wire grids is absorbed by the electrons in the metal wire grids, and the electric vector perpendicular to the direction of the metal wire grid can be transmitted, so that only the photons along the longitudinal direction of the metal wire grids can be absorbed, and the photons along the lateral direction cannot be absorbed, so that the linear polarized light is obtained. Based on the above principle, the polarization direction of the metal wire grid polarizer is perpendicular to the arranging direction of the metal wire grids. Therefore, the polarization direction of the metal wire grid polarizer can be controlled by setting the arranging direction of the metal wire grids.

For example, because the first polarizer 20 is divided into the plurality of first polarizing structures 201, and the polarization directions of the plurality of first polarizing structures 201 are not all identical, one sheet of the first polarizer 20 includes a plurality of polarization directions. Compared with other types of polarizers, because the polarization direction of the metal wire grid polarizer can be controlled by setting the arranging direction of the metal wire grids, it is easier to provide different polarization directions at different positions of one sheet of the metal wire grid polarizer.

For example, in the embodiments of the present disclosure, in order to simplify the manufacturing process of the curved display panel, the first polarizer 20 is a metal wire grid polarizer, and each of the first polarizing structures 201 includes a plurality of metal wire grids in a parallel arrangement.

For example, the polarization direction of the first polarizing structure 201 can be controlled by setting the arranging direction of the plurality of metal wire grids in a parallel arrangement in the first polarizing structure 201.

In some other embodiments of the present disclosure, according to practical application requirements, for example, in order to save the manufacturing cost, some of the first polarizing structures 201 may use the metal wire grids, and other first polarizing structures 201 may use, for example, other types of polarizing materials or structures. The embodiments of the present disclosure are not limited in this aspect.

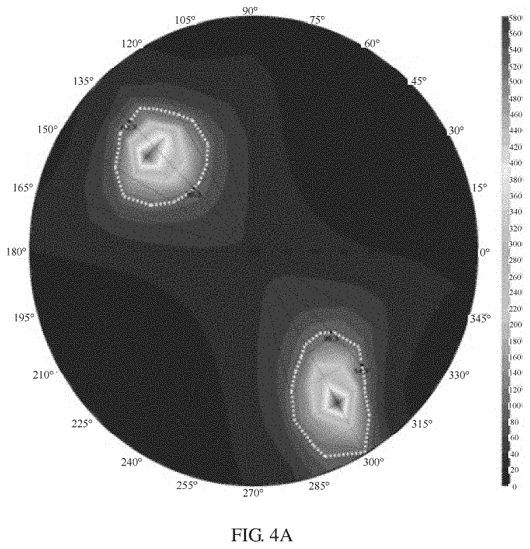

FIG. 3 is a structural schematic diagram of a first polarizer comprising three first polarizing structures provided by at least an embodiment of the present disclosure. For example, as illustrated in FIG. 3, polarization directions of the three first polarizing structures 201 are respectively indicated by double arrows below the first polarizer 20 in FIG. 3, that is, the polarization direction of the first polarizing structure 201 is perpendicular to the arranging direction of the metal wire grids.

For example, in the embodiments of the present disclosure, because the polarization direction of the metal wire grid polarizer can be controlled by adjusting the arranging direction of the metal wire grids, in order to simplify the manufacturing process of the curved display panel, the second polarizer 30 may also be a metal wire grid polarizer.

The display panel provided by the embodiments of the present disclosure can compensate for the influence of the extra optical retardation, which is generated in a case where the curved display panel is bent, on the polarization direction by setting the angle between the polarization direction of the first polarizing structure 201 and the polarization direction of the second polarizer 30, thereby alleviating the light leakage phenomenon of the curved display panel in the dark state and allowing the display panel to achieve a better display effect. Moreover, because the thickness of the glass of the curved display panel provided by the embodiments of the present disclosure does not need to be reduced, the production efficiency is not affected and the quality of the curved display panel is not reduced.

In the display panel provided by the embodiments of the present disclosure, because the first polarizer 20 and the second polarizer 30 can adjust the polarization direction of light, in the embodiments of the present disclosure, the influence of the extra optical retardation on the polarization direction of the light can be compensated by setting the angle between the polarization direction of each of the plurality of first polarizing structures 201 of the first polarizer 20 and the polarization direction of the second polarizer 30, thereby alleviating the light leakage phenomenon of the curved display panel in the dark state and allowing the curved display panel to achieve a better display effect.

For example, in the embodiments of the present disclosure, the polarization directions of the first polarizing structures 201 are not all perpendicular to the polarization direction of the second polarizer 30, and the value of the angle between the polarization direction of each of the first polarizing structures 201 and the polarization direction of the second polarizer 30 is not limited. For example, the angle between the polarization direction of each of the first polarizing structures 201 and the polarization direction of the second polarizer 30 may be set according to the magnitude of the extra optical retardation generated at the position corresponding to each first polarizing structure 201.

It should be noted that the extra optical retardation is related to the bending degree (i.e., the bending radius) of the glass. The extra optical retardation generated in a case where the glass is bent is Δnd′, and Δnd′=(SOC*E*T²)/2R, in which SOC is a photoelastic coefficient corresponding to the glass, E is a Young's modulus, T is a thickness of the glass, and R is the bending radius. According to the calculation formula of the extra optical retardation, it can be obtained that in a case where the display panel is not bent, that is, R is infinite, the extra optical retardation is zero. Because the curved display panel has different bending degrees at different positions (for example, along the direction of the long side of the curved display panel, for example, along the horizontal viewing direction, the bending degrees at edges of the curved display panel are large, and the bending degree at an intermediate region is small or even zero), the extra optical retardations generated at different positions may be different from each other. For example, in a case where the extra optical retardation at a position is 0, the angle between the polarization direction of the first polarizing structure 201 corresponding to the position and the polarization direction of the second polarizer 30 is 90°.

In the embodiments of the present disclosure, in the first direction (i.e., the direction of the long side of the curved display panel), the first polarizer includes an intermediate region, and a first edge region and a second edge region respectively located on both sides of the intermediate region. Along a direction from the intermediate region to the first edge region, an angle between a polarization direction of each of the plurality of first polarizing structures and the polarization direction of the second polarizer gradually decreases; and along a direction from the intermediate region to the second edge region, an angle between a polarization direction of each of the plurality of first polarizing structures and the polarization direction of the second polarizer gradually decreases.

For example, generally, regarding the curved display panel, along the horizontal viewing direction of the curved display panel (i.e., the direction of the long side of the curved display panel), from the intermediate region to the edge region (e.g., from the intermediate region to the first edge region, or from the intermediate region to the second edge region), the bending degree of the curved display panel gradually increases, that is, from the intermediate region to the edge region, the extra optical retardation of the curved display panel gradually increases. Therefore, in the embodiments of the present disclosure, along the direction from the intermediate region of the first polarizer 20 to the edge region of the first polarizer 20, that is, along the direction from the intermediate region to the first edge region and along the direction from the intermediate region to the second edge region, the angle between the polarization direction of each first polarizing structure 201 and the polarization direction of the second polarizer 30 gradually decreases. In this way, along the horizontal viewing direction of the curved display panel, the compensation for the polarization direction of the light is gradually increased from the intermediate region to the edge region of the curved display panel, thereby better solving the light leakage problem of the curved display panel in the dark state.

For example, in the practical manufacturing process of the curved display panel, the extra optical retardation generated at the position corresponding to each of the first polarizing structures 201 can be directly detected by a detecting device. Alternatively, the bending radius at the position corresponding to each of the first polarizing structures 201 can be detected first, and then the extra optical retardation generated at the position corresponding to each of the first polarizing structures 201 can be obtained according to a corresponding relationship between the bending radius and the extra optical retardation. The embodiments of the present disclosure are not limited in this aspect.

Based on the above description, the following embodiments of the present disclosure take two specific detecting methods as an example to describe the determination of the angle between the polarization direction of each first polarizing structure 201 and the polarization direction of the second polarizer 30 based on the magnitude of the extra optical retardation generated at the position corresponding to each of the first polarizing structures 201.

For example, one detecting method may be: determining a functional relationship T′=f(Δnd′) between the actual light transmittance T′ and the extra optical retardation Δnd′ of the bended curved display panel in the dark state. According to the functional relationship between the extra optical retardation Δnd′ generated at the position corresponding to the first polarizing structure 201 and the actual light transmittance T of the curved display panel at the position corresponding to the first polarizing structure 201, the actual light transmittance T′ at the position corresponding to each first polarizing structure 201 is calculated. Then according to the corresponding relationship between the actual light transmittance T′ and the angle between the polarization direction of the first polarizing structure 201 and the polarization direction of the second polarizer 30, the angle between the polarization direction of each first polarizing structure 201 and the polarization direction of the second polarizer 30 is obtained.

For example, another detecting method may be: obtaining a relationship between the extra optical retardation generated at the position corresponding to the first polarizing structure 201 and a corrected value of polarization angle by simulation, and then according to the corrected value of polarization angle, modifying the angle between the polarization direction of each of the first polarizing structures 201 and the polarization direction of the second polarizer 30 based on the angle between the polarization direction of the first polarizing structure 201 (i.e., the polarization direction of the first polarizer 20) and the polarization direction of the second polarizer 30 of the traditional curved display panel (for example, in the traditional liquid crystal display panel, the angle between the polarization direction of each of the first polarizing structures 201, that is, the polarization direction of the first polarizer 20, and the polarization direction of the second polarizer 30 is 90°), so that the angle between the polarization direction of each first polarizing structure 201 and the polarization direction of the second polarizer 30 is obtained.

Table 1 is an example of the corresponding relationship between several extra optical retardations and corrected values of polarization angles, and the corresponding relationship is obtained by simulation.

TABLE 1

| corrected value of | | |
|---|---|---|
| polarization angle | extra optical retardation | contrast |
| 8° | 15 nm | 1000:1 |
| 6° | 12 nm | 1000:1 |
| 4.5° | 9 nm | 1000:1 |
| 3.5° | 6 nm | 1000:1 |
| 3° | 3 nm | 1000:1 |

According to Table 1, in a case where the extra optical retardation at the position corresponding to the first polarizing structure 201 is 15 nm, the corrected value of polarization angle is 8° according to the simulation result, so that the angle, which is obtained after the correction, between the polarization direction of the first polarizing structure 201 and the polarization direction of the second polarizer is 82°, that is, 90°−8°=82° Therefore, in the practical design process of the curved display panel, at the position corresponding to the first polarizing structure 201, the angle between the polarization direction of the first polarizing structure 201 and the polarization direction of the second polarizer 30 is 82°. Based on the simulation results, it can be seen that in a case where the angle between the polarization direction of the first polarizing structure 201 and the polarization direction of the second polarizer 30 is corrected, the contrast of the curved display panel at the position corresponding to the first polarizing structure 201 is 1000:1. Taking the existing 18.5 inch ADS curved display panel as an example, in a case where the extra optical retardation at a certain position of the curved display panel is 15 nm, the contrast of the curved display panel at the position is 40:1, which is obtained by detection. Therefore, it can be seen that in a case where the angle between the polarization direction of the first polarizing structure 201 and the polarization direction of the second polarizer 30 is corrected, the light leakage phenomenon of the curved display panel in the dark state can be greatly alleviated, and the brightness of the dark state can be reduced, thereby significantly improving the contrast of the curved display panel and achieving a better display image.

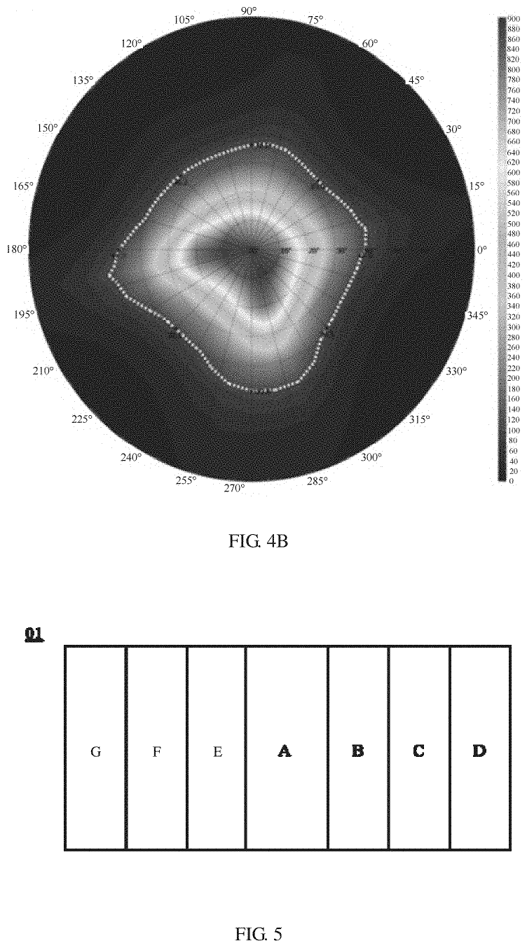

FIG. 4A is a schematic diagram of a contrast simulation result in a case where a polarization direction of a first polarizer and a polarization direction of a second polarizer are perpendicular to each other provided by at least an embodiment of the present disclosure, and FIG. 4B is a schematic diagram of a contrast simulation result in a case where polarization directions of first polarizing structures of a first polarizer are not all perpendicular to a polarization direction of a second polarizer provided by at least an embodiment of the present disclosure. The contrast simulation results illustrated in FIG. 4A and FIG. 4B correspond to the same curved display panel. For example, as illustrated in FIG. 4A, the contrast simulation result is obtained in a case where the polarization direction of the first polarizer 20 and the polarization direction of the second polarizer 30 are perpendicular to each other (i.e., before the correction of the polarization direction of the first polarizer 20 and the polarization direction of the second polarizer 30). For example, as illustrated in FIG. 4B, the contrast simulation result is obtained in a case where the polarization directions of the first polarizing structures 201 (where the first polarizer 20 is divided into the plurality of first polarizing structures 201) are not all perpendicular to the polarization direction of the second polarizer 30 (i.e., after the correction of the polarization direction of the first polarizer 20 and the polarization direction of the second polarizer 30). Compared FIG. 4A with FIG. 4B, it can be seen that the contrast of the curved display panel is good only in very few viewing angles in FIG. 4A, and the contrast of the curved display panel is good in almost each of the viewing angles in FIG. 4B. Therefore, in a case where the angle between the polarization direction of each of the first polarizing structures 201 and the polarization direction of the second polarizer 30 is corrected, the contrast of the curved display panel is greatly improved, and the light leakage phenomenon of the curved display panel in the dark state is alleviated, thereby allowing the curved display panel to achieve a better display effect.

For example, in some embodiments of the present disclosure, in the first direction (i.e., the direction of the long side of the display panel), the first polarizer includes an intermediate region, and a first edge region and a second edge region respectively located on both sides of the intermediate region. Each of the first edge region and the second edge region includes at least one sub-edge region, and sub-edge regions on both sides of the intermediate region are symmetrical with respect to a centerline of the display panel along the first direction. Each of the sub-edge regions includes one of the first polarizing structures, and polarization directions of first polarizing structures of symmetrical sub-edge regions have an identical angle with the polarization direction of the second polarizer.

In a specific embodiment provided below, the angle between the polarization direction of each first polarizing structure 201 in different regions and the polarization direction of the second polarizer 30 is set according to the extra optical retardations of different regions of the curved display panel.

FIG. 5 is a structural schematic diagram of a display panel being divided into seven regions along a direction of a long side of the display panel provided by at least an embodiment of the present disclosure. For example, as illustrated in FIG. 5, the curved display panel 01 is divided into seven regions along the direction of the long side (e.g., along the horizontal viewing direction), and for example, the seven regions comprise a intermediate region A, sub-edge regions B, C, D of the first edge region, and sub-edge regions E, F, G of the second edge region. The first polarizer 20 is divided into seven first polarizing structures 201, and one region (i.e., one intermediate region or one sub-edge region) of the curved display panel 01 corresponds to one first polarizing structure 201. For example, it can be obtained by detection that the extra optical retardation of the intermediate region A is 0 nm, the extra optical retardation of the sub-edge region B is 3 nm, the extra optical retardation of the sub-edge region C is 9 nm, and the extra optical retardation of the sub-edge region D is 15 nm.

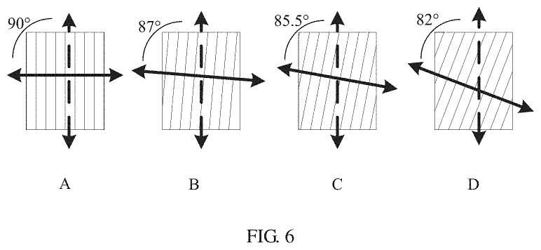

FIG. 6 is a structural schematic diagram of angles between a polarization direction of a first polarizing structure and a polarization direction of a second polarizer in partial regions of the display panel in FIG. 5. For example, as illustrated in FIG. 6, it can be obtained by calculation or simulation that the angle between the polarization direction of the first polarizing structure 201 of the intermediate region A and the polarization direction of the second polarizer 30 is 90°, the angle between the polarization direction of the first polarizing structure 201 of the sub-edge region B and the polarization direction of the second polarizer 30 is 87°, the angle between the polarization direction of the first polarizing structure 201 of the sub-edge region C and the polarization direction of the second polarizer 30 is 85.5°, and the angle between the polarization direction of the first polarizing structure 201 of the sub-edge region D and the polarization direction of the second polarizer 30 is 82°.

It should be noted that in FIG. 6, the solid-line double arrow indicates the polarization direction of the first polarizing structure 201, and the dashed-line double arrow indicates the polarization direction of the second polarizer 30.

For example, in some embodiments of the present disclosure, along the direction of the long side of the curved display panel 01 (e.g., the horizontal viewing direction), a plurality of sub-edge regions located on both sides of the intermediate region A are symmetrical with respect to a centerline of the curved display panel 01 along the horizontal viewing direction. For example, the sub-edge region B and the sub-edge region E are symmetrical with respect to the centerline of the curved display panel 01 along the horizontal viewing direction, the sub-edge region C and the sub-edge region F are symmetrical with respect to the centerline of the curved display panel 01 along the horizontal viewing direction, and the sub-edge region D and the sub-edge region G are symmetrical with respect to the centerline of the curved display panel 01 along the horizontal viewing direction. For example, polarization directions of first polarizing structures 201 in symmetrical sub-edge regions have an identical angle with the polarization direction of the second polarizer 30, that is, the angle between the polarization direction of the first polarizing structure 201 of the sub-edge region E and the polarization direction of the second polarizer 30 is 87°, the angle between the polarization direction of the first polarizing structure 201 of the sub-edge region F and the polarization direction of the second polarizer 30 is 85.5°, and the angle between the polarization direction of the first polarizing structure 201 of the sub-edge region G and the polarization direction of the second polarizer 30 is 82°.

It should be noted that, in the embodiments as illustrated in FIG. 5, each of the first edge region and the second edge region includes three sub-edge regions, and in some other embodiments of the present disclosure, each of the first edge region and the second edge region may also include other numbers of sub-edge regions. The embodiments of the present disclosure do not limit the number of sub-edge regions included in each of the first edge region and the second edge region. For example, one or more than two sub-edge regions may be included in each of the first edge region and the second edge region. For example, the number of sub-edge regions included in the first edge region and the number of sub-edge regions included in the second edge region may be the same, or may be different.

For example, because one sub-edge region is provided with one first polarizing structure 201, the number of sub-edge regions can be determined according to the size of the curved display panel 01 and the bending degree of the curved display panel 01. If the bending degree of the curved display panel 01 is large, and the number of the sub-edge regions is too small, that is, the number of the first polarizing structures 201 is too small, the compensation of some regions may be too much and the compensation of some regions may be too little when the influence of the extra optical retardation on the polarization direction is compensated by using the angle between the polarization direction of the first polarizing structure 201 and the polarization direction of the second polarizer 30. Thus, it is disadvantageous for effectively solving the problem of the light leakage of the curved display panel 01 in the dark state, and the light provided by the curved display panel 01 may be uneven. If the number of sub-edge regions is too large, the number of the first polarizing structures 201 is too large, which may increase the difficulty of manufacturing the first polarizer 20. Therefore, in the embodiments of the present disclosure, according to practical application requirements, each of the first edge region and the second edge region may include 2 to 100 sub-edge regions, thereby alleviating the light leakage phenomenon of the curved display panel in the dark state and reducing the difficulty of manufacturing the curved display panel, so that the yield of the curved display panel during the manufacturing process can be improved.

In some embodiments of the present disclosure, because the plurality of sub-edge regions (for example, the sub-edge region B and the sub-edge region E) located on both sides of the intermediate region A are symmetrical with respect to the centerline of the curved display panel 01 along the horizontal viewing direction, and the curved display panel is generally symmetrical with respect to the centerline along the horizontal viewing direction, the bending degrees of the positions corresponding to symmetrical sub-edge regions (for example, the sub-edge region B and the sub-edge region E) of the curved display panel 01 are identical. In addition, polarization directions of first polarizing structures 201 of symmetrical sub-edge regions (for example, the sub-edge region B and the sub-edge region E) have an identical angle with the polarization direction of the second polarizer 30. For example, the angle between the polarization direction of the first polarizing structure 201 of the sub-edge region B and the polarization direction of the second polarizer 30, and the angle between the polarization direction of the first polarizing structure 201 of the sub-edge region E and the polarization direction of the second polarizer 30 are both 87°. Therefore, at the positions where the bending degrees of the curved display panel 01 are identical, the polarization directions of first polarizing structures have an identical angle with the polarization direction of the second polarizer 30, so that at the positions where the bending degrees of the curved display panel 01 are identical, the compensations for the extra optical retardations are the same, thereby improving the optical uniformity of the curved display panel 01 and significantly improving the display quality of an image.

For example, in some embodiments of the present disclosure, in the direction of the long side of the curved display panel 01 (e.g., the horizontal viewing direction), the width of each of the sub-edge regions is the same, and for example, sub-edge regions B, C, D, E, F, G have the same width.

For example, because one sub-edge region is provided with one first polarizing structure 201, in the horizontal viewing direction of the curved display panel 01, the width of the first polarizing structure 201 may be the same as the width of the sub-edge region. Therefore, in a case where the width of each of the sub-edge regions is identical, the width of each of the first polarizing structures 201 is identical.

In the present embodiment, because the width of each of the first polarizing structures 201 is the same, in one aspect, the manufacturing process of the first polarizer 20 is simplified, and in another aspect, the manufactured first polarizing structure 201 can be applied to curved display panels (e.g., curved liquid crystal display panels) with the same width.

For example, in other embodiments of the present disclosure, widths of the plurality of sub-edge regions gradually decrease along the direction from the intermediate region to the first edge region; and widths of the plurality of sub-edge regions gradually decrease along the direction from the intermediate region to the second edge region. For example, widths of the sub-edge regions B, C. D may gradually decrease, or widths of the sub-edge regions E, F, G may gradually decrease.

For example, in a case where the curved display panel 01 is bent, because the bending degree of the intermediate region is smaller than the bending degree of the sub-edge region, the angle between the polarization direction of the first polarizing structure 201, which is corresponding to the position where the bending degree is large, and the polarization direction of the second polarizer 30 of the curved display panel 01 can be more accurately set by allowing the widths of the sub-edge regions to be gradually decreased along the direction from the intermediate region to the first edge region (or along the direction from the intermediate region to the second edge region). Therefore, the light leakage phenomenon of the curved display panel 01 in the dark state can be further effectively alleviated, thereby achieving a better display image.

At least an embodiment of the present disclosure further provides a display device, and the display device includes the display panel provided by any one of the embodiments of the present disclosure. For example, the display device may include the curved display panel 01 described above.

For example, the technical effects and implementation principles of the display device are the same as those of the display panel described in the embodiments of the present disclosure, and details are not described herein again. For example, the display device may be any product or component having a display function, such as a liquid crystal panel, an electronic paper, an OLED panel, a mobile phone, a tablet computer, a television, a display screen, a notebook computer, a digital photo frame, a navigator, etc. The embodiments of the present disclosure are not limited in this aspect.

For example, the display device (e.g., a curved display device) provided by the embodiments of the present disclosure can be any device that displays an image including a dynamic image (e.g., a video) or a fixed image (e.g., a still image) of words or pictures, etc.

For example, the display device provided by the embodiments of the present disclosure may be implemented in various electronic devices or be associated with various electronic devices. For example, the electronic devices may comprise (but not limited to) a mobile phone, a wireless device, a personal data assistant (PDA), a handheld or portable computer, a GPS receiver/navigator, a camera, an MP4 video player, a video camera, a game console, a watch, a clock, a calculator, a TV monitor, a flat panel display, a computer monitor, an automotive display (e.g., odometer display, etc.), a navigator, a cockpit controller and/or a display, a camera view display (e.g., a back vision camera display in a vehicle), an electronic photo, an electronic billboard or signboard, a projector, a building structure, a package structure, an aesthetic structure (for example, a display for displaying an image of a piece of jewelry), etc.

At least an embodiment of the present disclosure further provides a method for manufacturing a display panel, and the method includes: forming a liquid crystal layer, and disposing a first polarizer and a second polarizer respectively on both sides of the liquid crystal layer. The first polarizer includes a plurality of first polarizing structures, and a polarization direction of at least one of the first polarizing structures is not perpendicular to a polarization direction of the second polarizer.

The following statements should be noted:

(1) The accompanying drawings involve only the structure(s) in connection with the embodiment(s) of the present disclosure, and other structure(s) can be referred to common design(s).

(2) In case of no conflict, features in one embodiment or in different embodiments can be combined to obtain new embodiments.

What have been described above are only specific implementations of the present disclosure, the protection scope of the present disclosure is not limited thereto, and the protection scope of the present disclosure should be based on the protection scope of the claims.

1: A display panel, comprising: a liquid crystal layer, a first polarizer and a second polarizer,
wherein the first polarizer and the second polarizer are respectively on both sides of the liquid crystal layer; and
the first polarizer comprises a plurality of first polarizing structures, and a polarization direction of at least one of the first polarizing structures is not perpendicular to a polarization direction of the second polarizer.

2: The display panel according to claim 1, wherein the plurality of first polarizing structures are disposed along a first direction;
the display panel comprises a first side and a second side, and the first side is longer than the second side; and
the first direction is parallel to a direction of the first side of the display panel.

3: The display panel according to claim 1, wherein the first polarizer comprises a wire grid polarizer, and
at least one of the first polarizing structures comprises a plurality of wire grids in a parallel arrangement.

4: The display panel according to claim 3, wherein the wire grid polarizer is a metal wire grid polarizer, and
each of the first polarizing structures comprises a plurality of metal wire grids in a parallel arrangement.

5: The display panel according to claim 1, wherein polarization directions of the plurality of first polarizing structures of the first polarizer are not all identical, and the polarization direction of the second polarizer is identical at each position of the second polarizer.

6: The display panel according to claim 2, wherein in the first direction, the first polarizer comprises an intermediate region, and a first edge region and a second edge region respectively on both sides of the intermediate region;
along a direction from the intermediate region to the first edge region, an angle between a polarization direction of each of the first polarizing structures and the polarization direction of the second polarizer gradually decreases; and
along a direction from the intermediate region to the second edge region, an angle between a polarization direction of each of the first polarizing structures and the polarization direction of the second polarizer gradually decreases.

7: The display panel according to claim 2, wherein in the first direction, the first polarizer comprises an intermediate region, and a first edge region and a second edge region respectively on both sides of the intermediate region;
each of the first edge region and the second edge region comprises at least one sub-edge region, and sub-edge regions on both sides of the intermediate region are symmetrical with respect to a centerline of the display panel along the first direction; and
each of the sub-edge regions comprises one of the first polarizing structures, and polarization directions of first polarizing structures of symmetrical sub-edge regions have an identical angle with the polarization direction of the second polarizer.

8: The display panel according to claim 7, wherein each of the first edge region and the second edge region comprises 2 to 100 sub-edge regions.

9: The display panel according to claim 7, wherein each of the sub-edge regions has an identical width in the first direction.

10: The display panel according to claim 7, wherein along the direction from the intermediate region to the first edge region, widths of the plurality of sub-edge regions gradually decrease; and
along the direction from the intermediate region to the second edge region, widths of the plurality of sub-edge regions gradually decrease.

11: The display panel according to claim 1, wherein the second polarizer is a metal wire grid polarizer.

12: The display panel according to claim 1, wherein the display panel is a curved display panel.

13: The display panel according to claim 1, wherein the display panel is an advanced super dimension switch display panel.

14: The display panel according to claim 1, wherein the second polarizer comprises a plurality of second polarizing structures, and polarization directions of at least two of the second polarizing structures are different from each other.

15: The display panel according to claim 1, wherein the plurality of first polarizing structures are disposed along a second direction;
the display panel comprises a first side and a second side, and the first side is longer than the second side; and
the second direction is parallel to a direction of the second side of the display panel.

16: A display device, comprising the display panel according to claim 1.

17: A method for manufacturing a display panel, comprising:
forming a liquid crystal layer; and
disposing a first polarizer and a second polarizer respectively on both sides of the liquid crystal layer,
wherein the first polarizer comprises a plurality of first polarizing structures, and a polarization direction of at least one of the first polarizing structures is not perpendicular to a polarization direction of the second polarizer.

18: The display panel according to claim 2, wherein the first polarizer comprises a wire grid polarizer, and
at least one of the first polarizing structures comprises a plurality of wire grids in a parallel arrangement.

19: The display panel according to claim 2, wherein polarization directions of the plurality of first polarizing structures of the first polarizer are not all identical, and the polarization direction of the second polarizer is identical at each position of the second polarizer.

20: The display panel according to claim 3, wherein polarization directions of the plurality of first polarizing structures of the first polarizer are not all identical, and the polarization direction of the second polarizer is identical at each position of the second polarizer.
